(19) United States
(12) Patent Application Publication
(10) Pub. No.: US 2009/0137711 A1
(43) Pub. Date: May 28, 2009

(54) Moisture curable structural adhesive composition and method of applicatiion

(76) Inventors: Philip C. Georgeau, Kalamazoo, MI (US); Jonathan H. Ballema, Kalamazoo, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/324,223

(22) Filed: Nov. 26, 2008

Related U.S. Application Data
(60) Provisional application No. 60/990,852, filed on Nov. 28, 2007.

(51) Int. Cl. C08K 5/10

(52) U.S. Cl. 524/270

(57) ABSTRACT

A moisture curable structural adhesive composition containing a polymer having reactive silyl groups and having many advantages over conventional construction and structural adhesive compositions, including: high shear values, elastomeric properties, low temperature ductility, fast speed of cure and no out gassing on wet surfaces. The composition is also free of carcinogens such as coal tar, toxic isocyanates, and hazardous volatile solvents.

### CROSS-REFERENCE TO RELATED APPLICATIONS

This application claims the benefit under 35 U.S.C. §119(e) to pending Provisional Patent Application No. 60/990,852, filed on Nov. 28, 2007, the entire disclosure of which is incorporated by reference.

### FIELD OF THE INVENTION

This invention relates to adhesive compositions, and more particularly to moisture-curable adhesive compositions that are capable of bonding structural members without releasing hazardous organic compounds.

### BACKGROUND OF THE INVENTION

In the past mechanical fasteners were used by the construction industry almost exclusively, while adhesives were used in niche areas, such as paneling, if at all. There are increasing demands of the construction industry to build bigger and stronger structures. There is also a need for adhesives to replace and/or reinforce mechanical fasteners. Adhesives used in construction have evolved from low performance high solvent formulations to higher performance formulations, but many remain high solvent formulations. In the realm of structural and construction adhesives there is still room for improvement in performance and especially in the areas of safety and environmental impact.

Decorative paneling adhesive is one of the progenitors to construction and structural adhesives. In post WWII America the housing market was extremely high volume. In many of these rapidly produced houses paneling was a popular interior wall finish. While paneling is relatively cheap compared to plastered walls, paneling presented specific challenges. Securing paneling to walls with nails often results in splintering and sagging of the paneling. To overcome the splintering and sagging issues, decorative paneling adhesive was developed. Decorative paneling adhesive was cheap to produce and adhered paneling to walls without damage and warping issues inherent in using nails to mount the paneling.

While filling a need by replacing nails, decorative paneling needed to improve in a number of areas. Panel bonding adhesive formulations were exclusively solvent release systems. Solvent release adhesive systems pose health and environmental risks, not present in 100% solids adhesive systems. Additionally, shear performance and longevity issues plagued early panel adhesive products. The average shear values of paneling adhesive, approximately 100 pounds per square inch, were poor compared to nails, and many paneling adhesive bonds would fail after 3-5 years.

New adhesive formulations made in the 1960's increased shear performance from 100 pounds per square inch to around 200 pounds per square inch. However longevity remained an issue. Additionally, increased dwelling size and new requirements regarding performance in hurricanes and earthquakes demanded still higher performance from construction and structural adhesives.

Solvent release and water based adhesives were developed in the late 1960's and marked a significant leap in construction adhesive performance. When used in sub-flooring, these adhesives were shown to increase load capacity by an order of 3-4 times while decreasing the amount of material needed as well as decreasing labor costs. While the performance characteristics of solvent release adhesives were adequate for bonding decorative paneling, the solvent release adhesives were often only 50-60% solids and left numerous voids in the glueline. Additionally the solvent release adhesives often utilized aromatic solvents and hexane. Aromatic solvents present many potentially severe health effects and hexane is a known carcinogen.

Current products used in the construction and structural adhesive market include urethanes and water based adhesives. Examples of commercially available solvent release construction adhesives include: PL Plus produced by OSI and Liquid Nails® produced by ICI. Nail Power produced by Henkel is an example of a water based construction adhesive. These products provide approximate shear values of 350-600 pounds per square inch when used in wood to wood bonding. However, the solvent release products utilize aromatic solvent release systems of curing, making their use problematic for a number of reasons. First, many aromatic solvents have been classified as carcinogens and/or mutagens. Second, aromatic solvents are typically extremely flammable. Application of water based adhesives at low temperatures is often difficult or impossible.

Health and work place condition concerns are abundant when using these solvent release and urethane adhesives. The solvents released by many solvent adhesives are very flammable. Flammability concerns are exacerbated when used in confined or enclosed spaces. Confined and enclosed spaces are abundant on modern construction sites. Many of the solvents releases by solvent release adhesives are aromatic solvents. Some aromatic solvents used in solvent release adhesives and isocyanates used in urethane adhesives have been classified as carcinogenic and mutagenic by government agencies of the United States. Solvent neuropathology studies have shown the serious effects of repeated exposure to aromatic solvents. See: Solvent Neurotoxicity, Peter Arlien-Søborg, 1992, CRC Press, ISBN 0849362342. See also: Neuropsychological Dysfunction, Mood Disturbance, and Emotional Status of Munitions Workers, Bowler et al, Applied Neuropsychology, 2001, Vol. 8, No. 2, Pages 74-90. Urethane adhesives typically utilize an isocyanate cure system. Isocyanates are classified as mutagenic by government agencies of the United States and are currently banded in Scandinavian nations. There is an overall movement within regulatory agencies to phase out the use of isocyanates and hazardous aromatic solvents.

Solvent release adhesives and urethanes also pose serious environmental problems. Volatile organic compounds (VOC.'s) are often released when solvent release and urethane adhesives are cured. VOC's are said to contribute to global warming. Some of the solvents utilized by urethanes and solvent release adhesives are classified as Photoreactive compounds. Photoreactive compounds contribute to smog and are especially problematic in urban and suburban areas.

Water based construction adhesives based on Acrylic poly vinyl acetate systems do not rely on solvent release to cure. However, water based adhesives are very difficult to use in low temperatures due to freezing and rapid slowing of cure rates as temperatures approach 32° Fahrenheit. Transport of water based adhesives at low temperatures can be problematic, especially for the contractor using an open air “pick-up” truck. Bonding wood surfaces with water based adhesives at temperatures near freezing, is virtually impossible.

Current products provide sufficient shear strength but still have much room for improvement. A summary of the disadvantages for current solvent release adhesives and urethane adhesives include: flammability, health concerns and environmental impact, while water based adhesives are not suitable for transport or application in cold temperatures.

What is needed is a solvent free, structural adhesive with a much higher performance profile that releases a minimal amount of VOC's. The product should be safer, less flammable, present fewer health issues, have less of an environmental impact, while providing comparable shear values, faster cure, capable of use in low temperatures, capable of use in high humidity conditions and have a competitive price. The product should be usable in low temperature and high humidity conditions.

### SUMMARY OF THE INVENTION

The invention provides an improved moisture-curable adhesive composition that may be formulated to contain a minimal amount of volatile organic compounds (VOCs), safe for chronic exposure, and non-flammable. The adhesive compositions of this invention can be formulated into high performance structural adhesives that provide high shear values when bonding wood to wood and bonding metal to metal. The adhesive compositions of the invention can also be formulated to perform in high humidity and in low temperature. The adhesive compositions of this invention include a polymer having silicon-containing hydrolyzable terminal groups, and optionally a non-polymeric silicon-containing hydrolyzable compound. The invention further provides methods of using the adhesive in structural applications. The invention further provides methods of using the adhesive to mitigate wind damage in new and existing roof structures.

These and other features, advantages and objects of the present invention will be further understood and appreciated by those skilled in the art by reference to the following specification and claims.

### DETAILED DESCRIPTION OF PREFERRED EMBODIMENTS

The adhesive compositions in accordance with this invention comprise a polymer or a combination of polymers having silicon-containing hydrolyzable terminal groups, an organometalic catalyst, a plasticizer, a rosin ester, a reinforcing pigment or combination of reinforcing pigments and fillers and/or extenders. Solvent-free and substantially solvent-free adhesive compositions (i.e., containing minor amounts of VOCs that do not present a significant environmental burden, health risk or fire hazard, ranging from incidental impurities not to exceed to about 3% by weight of the composition) in accordance with the invention are safe for chronic exposure and are relatively resistant to combustion as compared with conventional solvent-based adhesive compositions. Solvent-free and/or substantially solvent-free compositions that do not release toxic and/or noxious fumes, volatile organic compounds, or explosive and/or highly flammable compounds during application of the adhesive composition in an open atmosphere can be formulated in accordance with an aspect of this invention.

The term “silicon-containing hydrolyzable terminal group” as used herein means a group wherein at least one silicon atom is combined with a hydrolyzable group such as a methoxy group which is subject to hydrolysis, condensation and/or polymerization by moisture.

The backbone of the polymer having silicon-containing hydrolyzable terminal groups may be comprised of polyethers, polyesters, polyurethanes (SPUR), polyurethanes (SPUR)+prepolymer blend, or other suitable backbones.

Suitable polymers having silicon-containing hydrolyzable terminal groups are commercially available and/or can be prepared in accordance with techniques known in the art. Examples of suitable commercially available polymers having silicon-containing hydrolyzable terminal groups are Geniosil™. STP-E 35 trimethoxysilylpropyl-carbamate-terminated polyether, and Geniosil™. STP-E 30 silane-terminated polyether with dimethoxy(methyl)silylmethylcarbamate terminal groups, both of which are available from Wacker Chemical. Another commercially available polymer having silicon-containing hydrolyzable terminal groups that may be employed in the adhesive compositions of this invention is “SPUR+” silane-terminated polyurethanes, available from General Electric Momentive. Another suitable commercially available material is “MS” silyl-terminated polyether (MS 303), available from Kaneka. The polymer portion of the instant invention is typically present in an amount from 12% by weight to 30% by weight of the total weight of the adhesive composition.

In the curable compositions of the present invention, there may further be added, when necessary, various additives such as dehydrating agents, tackifiers, physical property modifiers, storage stability improving agents, fillers, antioxidants, adhesion promoters, ultraviolet absorbers, metal deactivators, antiozonants, light stabilizers, lubricants, pigments, anti-foaming agents, flame retardants and antistatic agents, each in an adequate amount. A preferred embodiment of the instant invention contains a thixatrope or combination of thixatropes present in an amount ranging from 1.0% by weight to 2.0% by weight. A typical formulation of the instant invention typically contains a UV absorber, a light stabilizer and an antioxidant present in substantially equivalent amounts and about 1.0% by weight to 2.0% by weight, of the adhesive formulation.

The fillers mentioned above include, but are not limited to, wood meal, walnut shell flour, rice hull flour, pulp, cotton chips, mica, graphite, diatomaceous earth, china clay, kaoline, clay, talc, fumed silica, precipitated silica, silicic anhydride, quartz powder, glass beads, calcium carbonate, magnesium carbonate, titanium oxide, carbon black, glass balloons, aluminum powder, zinc powder, asbestos, glass fiber, fly ash and carbon fiber. The above fillers may be used individually or in combination. The filler portion of the instant invention may be as high as 70% by weight, with a preferred amount of 61% of the total weight of the adhesive composition.

Optional additives that do not adversely affect and may enhance the essential characteristics and features of the invention include a catalyst that promotes moisture curing, and conventional amounts of conventional additives, such as dehydrating agents, compatibilizers, tactifiers, physical property modifiers, storage stability improving agents, antioxidants, adhesion promoters, metal deactivators, antiozonants, light stabilizers, a plasticizer or combination of plasticizers, lubricants, pigments, foaming agents, flame retardants and antistatic agents. A preferred embodiment of the instant invention contains a plasticizer present in an amount ranging from 15% by weight to 20% by weight. A preferred embodiment of the present invention may contain an adhesion promoter or combination of adhesion promoters present in an amount ranging from 1.5% by weight to 2.5% by weight. A preferred embodiment of the present invention may contain a catalyst or combination of catalysts present in an amount ranging from 0.05% by weight to 0.25% by weight. A preferred embodiment of the invention may contain a rosin ester in an amount of from 1% to 15% by weight of the total composition.

The instant invention has a safety profile superior to most other construction adhesives. Solvent free formulations of the instant invention present lower flammability risk, lower inhalation risk, low VOC emissions, and are safer to use in confined spaces. The instant invention can also be formulated to be free of Isocyanates. Isocyanates are used in urethane adhesives. Isocyanates have been identified by OSHA as a potential carcinogen. Health effects of isocyanate exposure include irritation of skin and mucous membranes, chest tightness, and difficult breathing. Isocyanates include compounds classified as potential human carcinogens and known to cause cancer in animals. The main effects of hazardous exposures are occupational asthma and other lung problems, as well as irritation of the eyes, nose, throat, and skin.

The adhesive of the instant invention can be formulated to be environmentally friendly. The formulations of the invention produce no VOC emissions, no greenhouse gas emission, and no smog producing photo-reactive emissions.

The adhesive of the instant invention can be formulated to bond at low temperatures (20 to 30 degrees Fahrenheit.) Water based construction and structural adhesives have problems curing at low temperatures.

An adhesive formulation in accordance with the instant invention has passed the American Plywood Association test, AFG-01. The instant invention exceeds the required shear strength of 150 pounds for a bond of 1.5 inches wide by 1 inch long to frozen lumber, required to pass the frozen lumber portion of AFG-01. The instant invention substantially exceeds the required shear strength of 150 pounds for a bond of 1.5 inches wide by 1 inch long to frozen lumber and the required shear strength of 225 pounds for a bond of 1.5 inches wide by 1 inch long to wet lumber tests of AFG-01. To the inventor's knowledge the instant invention is the first polyether based construction or structural adhesive to exceed the requirements of the AFG-01 frozen lumber test.

The AFG-01 standard specifying Adhesives a for Field-Gluing Plywood to Wood Framing was developed by the American Plywood Association and adopted by HUD (UM-60) as a minimum property construction standard. The AFG-01 standard has been widely adopted by the construction industry as a benchmark for sub-floor and construction adhesives.

AFG-01 has 7 distinct test requirement distributed through 2 performance categories, shear strength and durability. The shear strength category has 4 distinct tests. The shear category testes include; wet lumber adhesion, frozen lumber adhesion, dry lumber adhesion, and the gap filing tests. The durability category tests include moisture resistance and oxidation resistance tests. To pass the AFG-01 testing standard a construction adhesive must pass all 7 tests. The AFG-01 standard is available in its entirety from the American Plywood Association, ASTM, and HUD.

The adhesive of the instant invention can be formulated to provide superior green strength and faster cure than products currently on the market.

The instant invention may be formulated to bond metal to metal, and is particularly useful in bonding metal to corrugated steel. The instant invention may be formulated for use in wood frame construction, and is particularly useful in sub-floor bonding. The instant invention may be formulated for use in manufactured housing. The instant invention may be formulated for use in side wall adhesion, particularly in Recreational Vehicles. The instant invention may be formulated for use in concert with gussets to strengthen roofing and mitigate wind damage.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A moisture curable composition comprising:
a polymer having silicon-containing hydrolyzable terminal groups;
an organometalic catalyst;
a plasticizer;
a rosin ester;
a reinforcing pigment; and
a filler or combination of fillers.

2. The moisture curable composition of claim 1, wherein the polymer having silicon containing hydrolysable terminal groups is selected from a group consisting of a silyl terminated polyurethane, a silyl terminated polyether, and a silyl terminated polyester.

3. The moisture curable composition of claim 2, wherein the rosin ester is present in an amount between 1% to 15% by weight of the total composition.

4. The moisture curable composition of claim 3, wherein the moisture curable composition adheres to lumber and demonstrates properties to satisfy all the requirements of AFG-01 testing protocol.

5. The moisture curable composition of claim 3, wherein the moisture curable composition adheres to wet lumber sufficiently to pass the AFG-01 testing protocol.

6. The moisture curable composition of claim 3, wherein the moisture curable composition adheres to frozen lumber sufficiently to pass the AFG-01 testing protocol.

7. The moisture curable composition of claim 3, wherein the moisture curable composition adheres to dry lumber sufficiently to pass the AFG-01 testing protocol.

8. The moisture curable composition of claim 3, wherein the moisture curable composition has sufficient oxidation resistance to pass the AFG-01 testing protocol.

9. The moisture curable composition of claim 3, wherein the moisture curable composition has sufficient gap filling properties to pass the AFG-01 testing protocol.

10. The moisture curable composition of claim 4, wherein the moisture curable composition has shear strength values greater than 500 pounds per square inch on untreated wood substrates.

11. The moisture curable composition of claim 5, wherein the moisture curable composition develops shear strength values greater than 300 pounds per square inch on wood and plywood substrates in a time period of less than 3 hours.
